(19) United States
(12) Patent Application Publication
(10) Pub. No.: US 2024/0106025 A1
(43) Pub. Date: Mar. 28, 2024

(54) BATTERY PACK

(71) Applicant: MURATA MANUFACTURING CO., LTD., Kyoto (JP)

(72) Inventor: Yoshiyuki BANNAI, Kyoto (JP)

(21) Appl. No.: 18/226,976

(22) Filed: Jul. 27, 2023

(30) Foreign Application Priority Data
Sep. 22, 2022 (JP) 2022-151840

(51) Int. Cl. H01M 10/6555; H01M 10/613; H01M 10/643; H01M 10/653; H01M 50/213

(52) U.S. Cl. CPC H01M 10/6555; H01M 10/613; H01M 10/643; H01M 10/653; H01M 50/213

(57) ABSTRACT

To provide a battery pack including a heat-absorbing member capable of suppressing permeation of a heat-absorbing agent. A battery pack includes a secondary battery and a heat-absorbing member that includes a heat-absorbing agent and an exterior member accommodating the heat-absorbing agent and is in contact with the secondary battery at least in part, wherein the exterior member includes a metal layer, a resin layer overlapping the metal layer, and a sealing portion sealing the heat-absorbing agent, the metal layer is located inside the exterior member, and the metal layers are joined to each other at the sealing portion.

### CROSS REFERENCE TO RELATED APPLICATIONS

The present application claims priority to Japanese patent application no. 2022-151840, filed on Sep. 22, 2022, the entire contents of which are incorporated herein by reference.

### BACKGROUND

The present disclosure relates to a battery pack.

An example of a battery pack, a battery module is described including a heat-absorbing member and a plurality of battery cells. The heat-absorbing member includes a heat-absorbing agent and an exterior film enclosing the heat-absorbing agent. The exterior film includes a metal film and a resin layer stacked on both surfaces of the metal film. In the heat-absorbing member, the exterior film is stacked, and a portion where the exterior film is stacked is fused to seal the heat-absorbing agent.

### SUMMARY

The present disclosure relates to a battery pack.

However, in the exterior film (exterior member) of the battery pack described in the Background section, the resin layers are arranged on both surfaces of the metal film (metal layer), and the resin layers are joined to each other at a portion where the exterior member is fused. The heat-absorbing agent adheres to an inner surface of the resin layer. The resin layer contains numerous fine voids at a molecular level. Thus, moisture of the heat-absorbing agent leaks (permeates) to the outside through the fine voids from a portion where the resin layers are joined to each other. Therefore, in the battery module (battery pack) described in the Background section, there is a possibility that the amount of the heat-absorbing agent decreases. When the amount of the heat-absorbing agent decreases, safety of the battery pack may decrease.

The present disclosure relates to providing, in an embodiment, a battery pack including a heat-absorbing member capable of suppressing permeation of a heat-absorbing agent.

A battery pack of the present disclosure, in an embodiment, includes a secondary battery and a heat-absorbing member that includes a heat-absorbing agent and an exterior member accommodating the heat-absorbing agent and is in contact with the secondary battery at least in part, wherein the exterior member includes a metal layer, a resin layer overlapping the metal layer, and a sealing portion sealing the heat-absorbing agent, the metal layer is located inside the exterior member with respect to the resin layer, and the metal layers are joined to each other at the sealing portion.

According to the present disclosure, an embodiment, the heat-absorbing member included in the battery pack can suppress permeation of the heat-absorbing agent.

### BRIEF DESCRIPTION OF THE FIGURES

FIG. 1 is an exploded perspective view of a battery pack according to an embodiment of the present disclosure;

FIG. 2 is an exploded perspective view of a battery unit illustrated in FIG. 1;

FIG. 3 is a longitudinal sectional view of a secondary battery and a lead plate illustrated in FIG. 2;

FIG. 4 is a perspective view of a heat-absorbing member illustrated in FIG. 2;

FIG. 5 is a longitudinal sectional view of the heat-absorbing member illustrated in FIG. 4;

FIG. 6 is a transverse sectional view of the heat-absorbing member illustrated in FIG. 4;

FIG. 7A is a longitudinal sectional view of an exterior member illustrating a first manufacturing step of the heat-absorbing member;

FIG. 7B is a longitudinal sectional view of the exterior member illustrating a second manufacturing step of the heat-absorbing member;

FIG. 7C is an in-part enlarged sectional view of the heat-absorbing member illustrating a fourth manufacturing step of the heat-absorbing member;

FIG. 8 is an exploded perspective view of the exterior member of the battery pack according to a variation of an embodiment;

FIG. 9 is a transverse sectional view of the heat-absorbing member of the battery pack according to the variation of an embodiment;

FIG. 10 is a perspective view of a battery pack according to another embodiment of the present disclosure;

FIG. 11 is an exploded perspective view of a battery unit illustrated in FIG. 10;

FIG. 12 is a plan view of a secondary battery illustrated in FIG. 11; and

FIG. 13 is a sectional view of the heat-absorbing member illustrated in FIG. 11.

### DETAILED DESCRIPTION

Hereinafter, one or more embodiments will be described in further detail including with reference to the drawings. Note that the present disclosure is not limited to the embodiments. Each embodiment is illustrative, and it goes without saying that replacement and combination of a part of configurations shown in the different embodiments can be performed.

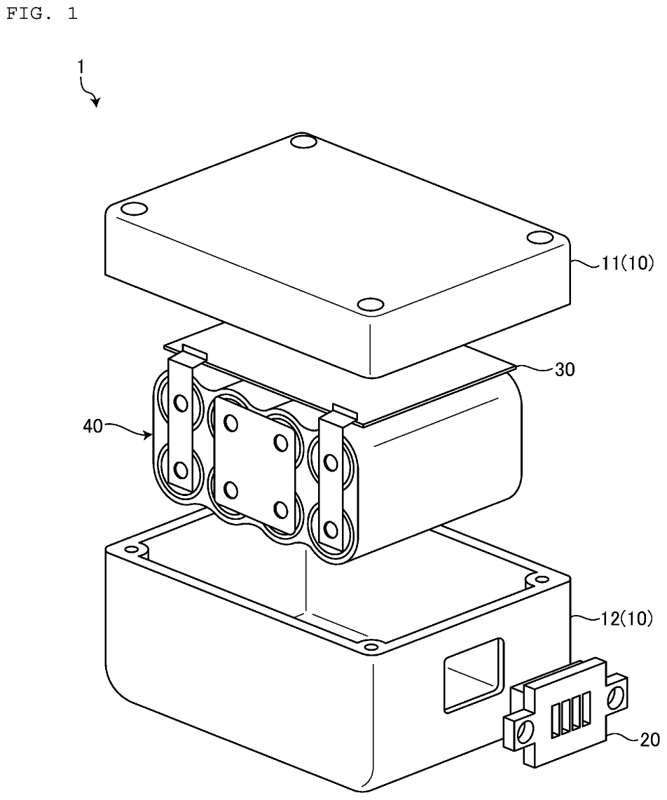

FIG. 1 is an exploded perspective view of a battery pack 1 according to an embodiment of the present disclosure. The battery pack 1 can be applied as a power source to an external device (not illustrated) such as an electronic device, an electric vehicle, and an electric tool. The battery pack 1 includes an exterior case 10, a connector 20, a control board 30, and a battery unit 40.

The exterior case 10 has a box shape and houses the control board 30 and the battery unit 40. The exterior case 10 includes a first case portion 11 and a second case portion 12.

The connector 20 is attached to the exterior case 10. The connector 20 electrically connects an external device and the battery unit 40 via the control board 30, and supplies (discharges) power of the battery unit 40 to the external device. Further, the connector 20 electrically connects a power supply (for example, a commercial power supply) and the battery unit 40 via the control board 30, and supplies (charges) power from the power supply to the battery unit 40. The control board 30 controls charging and discharging of the battery unit 40.

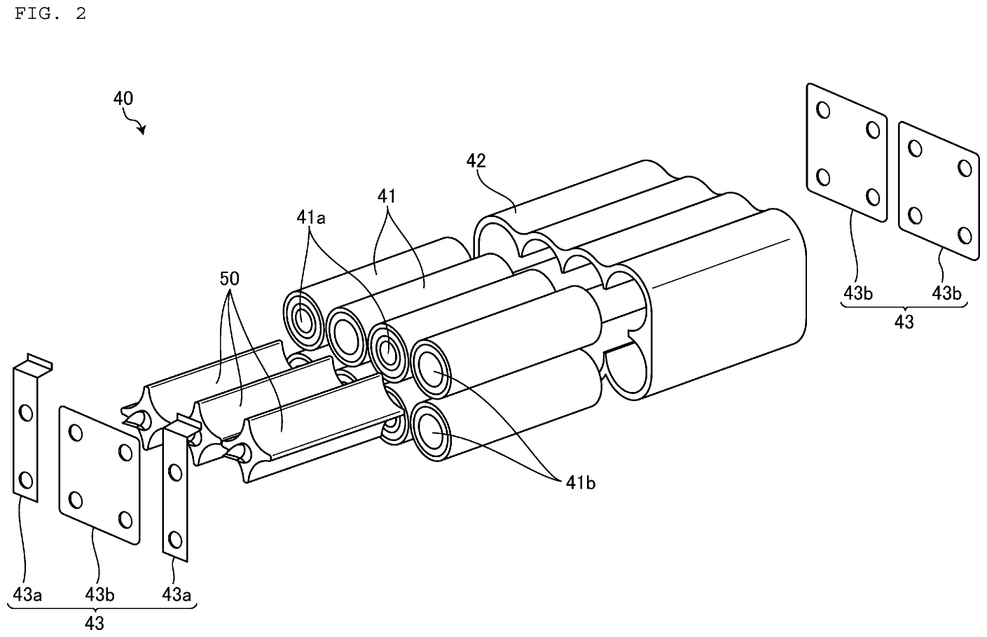

FIG. 2 is an exploded perspective view of the battery unit 40 shown in FIG. 1. The battery unit 40 includes a plurality of secondary batteries 41, a holder 42, a plurality of lead plates 43, and a plurality of heat-absorbing members 50.

The secondary battery 41 is, for example, a lithium ion battery. The secondary battery 41 has a cylindrical shape. In an embodiment, the number of the secondary batteries 41 is eight, but it goes without saying that the number is not limited to eight.

A plurality of the secondary batteries 41 are arranged in parallel. That is, axes of a plurality of the secondary batteries 41 are substantially parallel to each other. In an embodiment, the plurality of secondary batteries 41 are arranged in two rows. Further, in the plurality of secondary batteries 41, a direction of a positive electrode terminal 41a and a direction of a negative electrode terminal 41b are arranged in a predetermined direction.

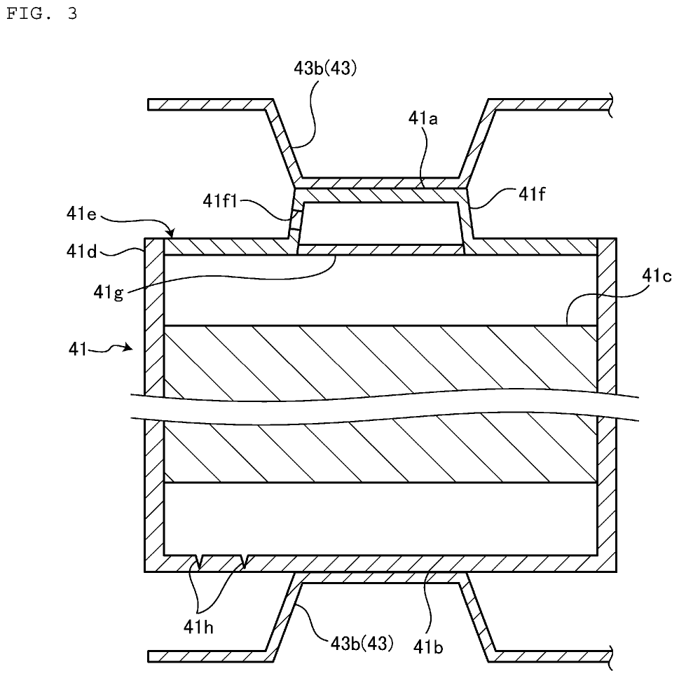

FIG. 3 is a longitudinal sectional view of the secondary battery 41 illustrated in FIG. 2 and the lead plate 43. In FIG. 3, the holder 42 and the heat-absorbing member 50 are not illustrated. The secondary battery 41 includes an electrode assembly 41c, a can 41d, and a lid 41e. The can 41d and the lid 41e are made from, for example, iron, stainless steel, or aluminum, and have conductivity.

The electrode assembly 41c is formed by laminating and winding a plurality of sheet-like positive electrodes (not illustrated) and a plurality of sheet-like negative electrodes (not illustrated) with a separator (not illustrated) interposed therebetween.

The can 41d has a tubular shape having an opening on one end side. The can 41d is electrically connected to a negative electrode of the electrode assembly 41c with current collecting foil (not illustrated) interposed therebetween. A central portion of an end surface on the other end side of the can 41d is a negative electrode terminal 41b of the secondary battery 41.

The lid 41e has a plate shape and covers an opening of the can 41d on one end side. The lid 41e and the can 41d are electrically insulated by an insulating member (not illustrated). The lid 41e is electrically connected to a positive electrode of the electrode assembly 41c with current collecting foil interposed therebetween.

The lid 41e has a protrusion 41f and a cleavage valve 41g. The protrusion 41f is located at the center of the lid 41e. A protruding end surface of the protrusion 41f is the positive electrode terminal 41a of the secondary battery 41. Further, a hole 41f1 that allows the inside and the outside of the secondary battery 41 to communicate with each other is provided on a side wall of the protrusion 41f. Note that a plurality of the holes 41f1 may be provided.

The cleavage valve 41g is arranged inside the protrusion 41f inside the secondary battery 41. Specifically, the cleavage valve 41g is arranged at a position that partitions a space communicating with the hole 41f1 inside the secondary battery 41 and a space where the electrode assembly 41c is located. When an internal pressure of the secondary battery 41 reaches or exceeds a predetermined value, the cleavage valve 41g is cleaved to be in an open state.

Further, a battery thin-walled portion 41h is provided on a side wall on the other end side of the can 41d. The battery thin-walled portion 41h is a portion having a small thickness on the side wall on the other end side of the can 41d. The side wall on the other end side of the can 41d is cleaved from the battery thin-walled portion 41h when the internal pressure of the secondary battery 41 becomes high. For example, in a case where the cleavage valve 41g is not in an open state when the internal pressure of the secondary battery 41 becomes a predetermined value or more, when the internal pressure of the secondary battery 41 further increases, the side wall on the other end side of the can 41d is cleaved from the battery thin-walled portion 41h.

The holder 42 illustrated in FIG. 2 holds the plurality of secondary batteries 41. The holder 42 mainly holds an outer peripheral surface of the secondary battery 41. Specifically, the holder 42 holds a portion of the secondary battery 41 other than a portion of the can 41d provided with the positive electrode terminal 41a, the negative electrode terminal 41b, the protrusion 41f, and the battery thin-walled portion 41h.

The lead plate 43 electrically connects the plurality of secondary batteries 41 in series or in parallel. Furthermore, the lead plate 43 electrically connects the plurality of secondary batteries 41 and the control board 30. The lead plate 43 includes a first lead plate 43a and a second lead plate 43b. The first lead plate 43a electrically connects two of the secondary batteries 41. The second lead plate 43b electrically connects four of the secondary batteries 41. It goes without saying that the number of the secondary batteries 41 electrically connected by the first lead plate 43a and the second lead plate 43b is not limited to the above numbers.

The heat-absorbing member 50 has a columnar shape and is disposed between the plurality of secondary batteries 41. A side surface of the heat-absorbing member 50 is in contact with the outer peripheral surface of the secondary battery 41. The heat-absorbing member 50 absorbs heat of the secondary battery 41 (the details will be described later). In an embodiment, although the number of the heat-absorbing members 50 is three, it goes without saying that the number is not limited to three.

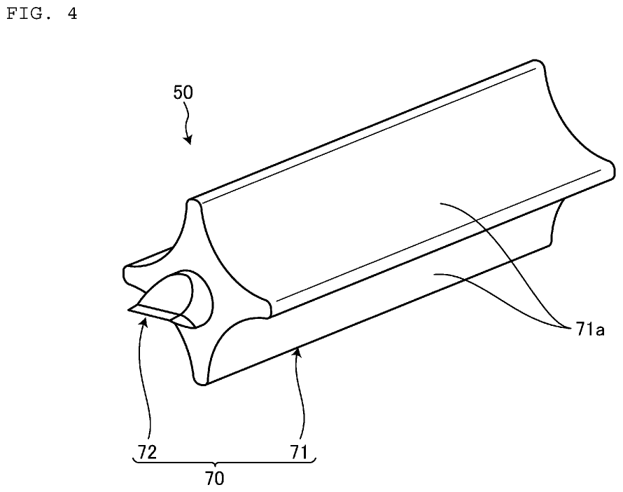

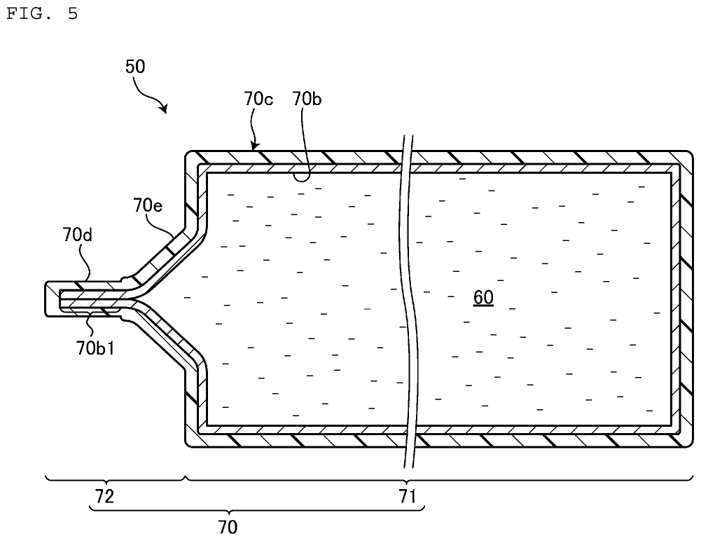

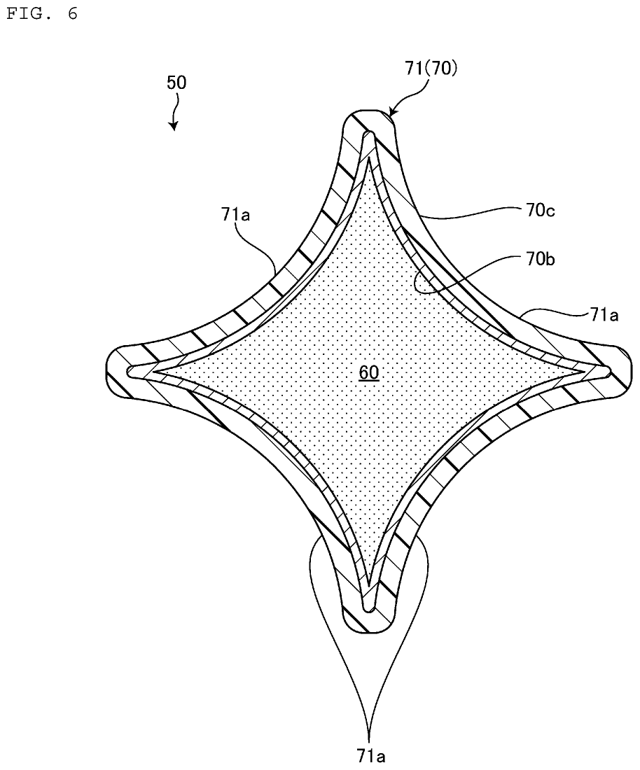

FIG. 4 is a perspective view of the heat-absorbing member 50 illustrated in FIG. 2. FIG. 5 is a longitudinal sectional view of the heat-absorbing member 50 illustrated in FIG. 4. FIG. 6 is a transverse sectional view of the heat-absorbing member 50 illustrated in FIG. 4. The heat-absorbing member 50 includes a heat-absorbing agent 60 and an exterior member 70.

The heat-absorbing agent 60 contains a substance that absorbs heat generated from the secondary battery 41. The main component of the heat-absorbing agent 60 is, for example, a liquid such as water. The heat-absorbing agent 60 may contain a gelling agent, a surfactant, and an anti-freezing agent. The heat-absorbing agent 60 may or may not have fluidity.

The exterior member 70 accommodates the heat-absorbing agent 60. The exterior member 70 has a hollow columnar shape. As illustrated in FIGS. 5 and 6, the exterior member 70 includes a metal layer 70b and a resin layer 70c. A combined thickness of the metal layer 70b and the resin layer 70c is between about 0.01 mm and 1.0 mm.

The metal layer 70b is located inside the exterior member 70 with respect to the resin layer 70c. The material of the metal layer 70b is an aluminum alloy. Specifically, the aluminum alloy is an alloy containing aluminum and magnesium. The aluminum alloy may be an alloy containing aluminum, magnesium, and silicon. The material of the metal layer 70b may be a nickel alloy or gold. The nickel alloy is, for example, an alloy containing nickel and copper.

The material of the metal layer 70b may be a single metal element selected from the group consisting of gold, aluminum, zinc, chromium, and nickel, or may be an alloy containing at least one metal element selected from this group. The material of the metal layer 70b can suppress permeation of the heat-absorbing agent 60 as compared with the material of the resin layer 70c as described later. The metal layer 70b may have a passive film. When the material of the metal layer 70b is any one of gold, an aluminum alloy, and a nickel alloy, corrosion of the metal layer 70b caused by contact of the heat-absorbing agent 60 can be suppressed.

The thickness of the metal layer 70b is smaller than the thickness of the resin layer 70c. The thickness of the metal layer 70b is between about 10 nm and 1 μm in an embodiment.

The water vapor transmission rate of the metal layer 70b measured in accordance with the provision of JIS K 7129 (Plastics-Film and sheeting, Determination of water vapor transmission rate-Part 1: Humidity sensor method) is about 1.0 (g/(m²·24 h)). The oxygen transmission rate of the resin layer 70c measured in accordance with the provision of JIS K 7126-2 (Plastics-Film and sheeting, Determination of gas-transmission rate-Part 2: Equal-pressure method) is about 1.0 (ml/(m²·24 h·MPa)). It goes without saying that the thickness of the metal layer 70b is not limited to the above thickness.

The resin layer 70c overlaps the metal layer 70b. The resin layer 70c is located outside the exterior member 70. That is, the resin layer 70c is stacked on the metal layer 70b outside the exterior member 70. In other words, the metal layer 70b is stacked on the resin layer 70c inside the exterior member 70, and is located inside the exterior member 70 with respect to the resin layer 70c.

The resin layer 70c is disposed outside the exterior member 70 with respect to the metal layer 70b over the entire metal layer 70b. That is, the metal layer 70b is wholly covered with the resin layer 70c. That is, the metal layer 70b is not exposed on an outer surface of the exterior member 70. Thus, corrosion of the metal layer 70b can be suppressed, and the secondary battery 41 and the lead plate 43 can be prevented from being electrically connected to the metal layer 70b. Therefore, it is possible to prevent the two secondary batteries 41 from being short-circuited.

The material of the resin layer 70c is a resin having electrical insulation properties. The material of the resin layer 70c is, for example, a simple substance of polyethylene terephthalate. The material of the resin layer 70c may be a simple substance of one of polypropylene, polyethylene, and polystyrene. The material of the resin layer 70c may be a synthetic resin containing at least one of polyethylene terephthalate, polypropylene, polyethylene, and polystyrene.

The thickness of the resin layer 70c is about 0.012 mm in an embodiment. The water vapor transmission rate of the resin layer 70c measured in accordance with the provision of JIS K 7129 is about 50 (g/(m²·24 h)). The oxygen transmission rate of the resin layer 70c measured in accordance with the provision of JIS K 7126-2 is about 100 (ml/(m²·24 h·MPa)). It goes without saying that the thickness of the resin layer 70c is not limited to the above thickness.

As illustrated in FIGS. 4 and 5, the exterior member 70 includes an accommodating portion 71 and a sealing portion 72. The accommodating portion 71 accommodates the heat-absorbing agent 60. Furthermore, the accommodating portion 71 has, on its side surface, a first curved surface 71a in contact with the outer peripheral surface of the secondary battery 41. As illustrated in FIG. 6, the first curved surface 71a has an arc shape in sectional view along the outer peripheral surface of the secondary battery 41. The accommodating portion 71 has four first curved surfaces 71a and has a rhombic shape in sectional view. It goes without saying that the number of the first curved surfaces 71a is not limited to four, and the accommodating portion 71 is not limited to a rhombic shape in sectional view.

As illustrated in FIGS. 4 and 5, the sealing portion 72 is formed continuously from the accommodating portion 71. The sealing portion 72 seals the heat-absorbing agent 60 and prevents leakage of the heat-absorbing agent 60. In the sealing portion 72, the metal layers 70b are joined to each other (the details will be described later).

Next, a manufacturing step of the heat-absorbing member 50 will be described. The manufacturing step of the heat-absorbing member 50 includes the following manufacturing step.

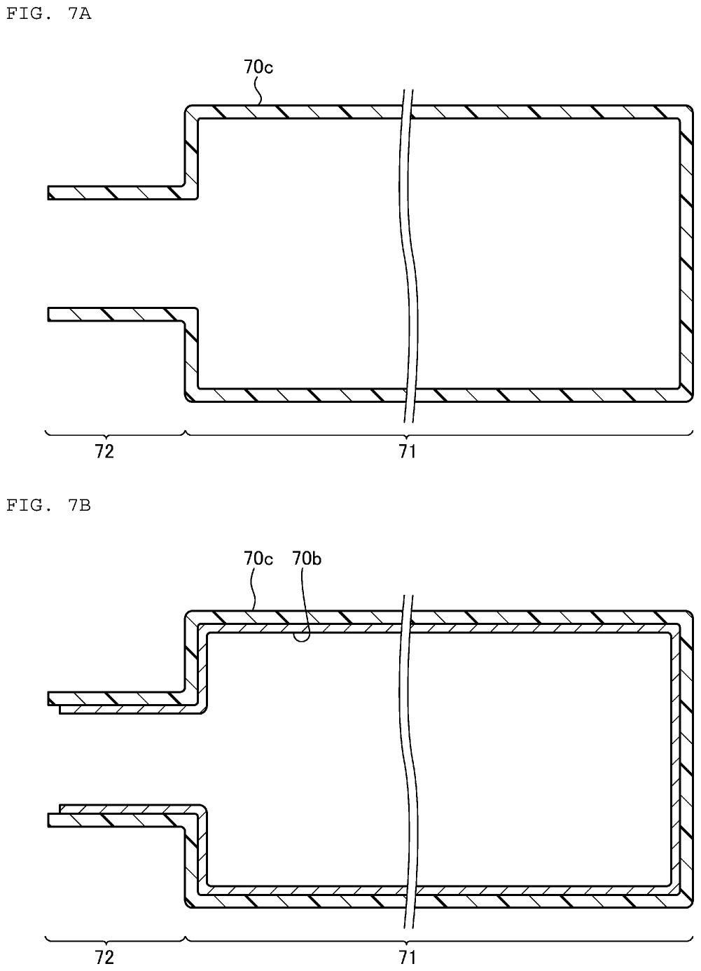

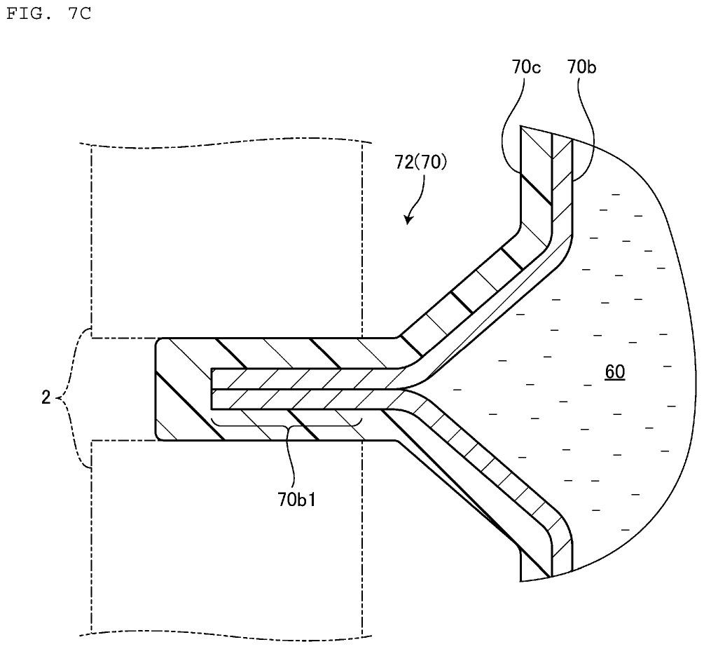

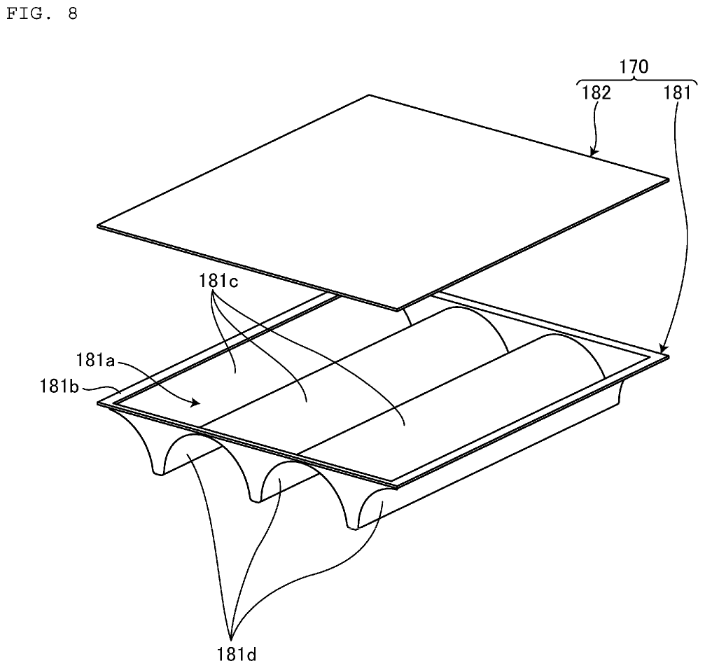

FIG. 7A is a longitudinal sectional view of the exterior member 70 illustrating a first manufacturing step of the heat-absorbing member 50. In the first manufacturing step of the heat-absorbing member 50, the resin layer 70c of the exterior member 70 is formed. The resin layer 70c is formed by, for example, blow molding or vacuum molding using the material of the resin layer 70c. In the first manufacturing step, the sealing portion 72 is opened.

FIG. 7B is a longitudinal sectional view of the exterior member 70 illustrating a second manufacturing step of the heat-absorbing member 50. In the second manufacturing step of the heat-absorbing member 50, the metal layer 70b of the exterior member 70 is formed. The metal layer 70b is formed by, for example, vapor deposition using the material of the metal layer 70b. In the second manufacturing step, the sealing portion 72 is opened. At an open end of the sealing portion 72, the metal layer 70b is not formed by masking treatment, for example.

In the third manufacturing step of the heat-absorbing member 50, the heat-absorbing agent 60 is accommodated in the exterior member 70.

FIG. 7C is an in-part enlarged sectional view of the heat-absorbing member 50 illustrating a fourth manufacturing step of the heat-absorbing member 50. In the fourth manufacturing step of the heat-absorbing member 50, an end portion of the sealing portion 72 is closed. Specifically, a pair of pressing members 2 sandwiches and presses the end portion of the sealing portion 72. As a result, a joint portion 70b1 where the metal layers 70b are joined to each other is formed. In the joint portion 70b1, the metal layers 70b overlap each other in a state of being in close contact with each other.

The pair of pressing members 2 is heated, and the temperature of the pair of pressing members 2 is adjusted to a predetermined temperature between the melting point of the resin layer 70c and the melting point of the metal layer 70b. As a result, the resin layers 70c are melted and joined to each other at the end portion of the sealing portion 72, and the resin layer 70c covers the metal layer 70b. The metal layer 70b is not melted.

By performing the fourth manufacturing step in this manner, as illustrated in FIG. 5, the resin layer 70c includes a thin-walled portion 70d and a thick-walled portion 70e. The thin-walled portion 70d is a portion of the resin layer 70c sandwiched between the pair of pressing members 2, and is a portion of the resin layer 70c overlapping the joint portion 70b1. The thick-walled portion 70e is a portion of the resin layer 70c not sandwiched by the pair of pressing members 2, and is a portion of the resin layer 70c other than the thin-walled portion 70d.

Since the joint portion 70b1 is covered with the resin layer 70c, the state in which the metal layers 70b are in close contact with each other and overlap each other is maintained. That is, the state in which the metal layers 70b are joined to each other is maintained.

The metal layer 70b is located inside the exterior member 70 with respect to the resin layer 70c, and directly surrounds the heat-absorbing agent 60. That is, the heat-absorbing agent 60 is not in contact with the resin layer 70c. That is, the heat-absorbing agent 60 that permeates through the exterior member 70 permeates through the metal layer 70b and then permeates through the resin layer 70c. In other words, the exterior member 70 has a structure in which the heat-absorbing agent 60 does not permeate to the outside only through the resin layer 70c.

As described above, the water vapor transmission rate of the metal layer 70b is about 1/50 of the water vapor transmission rate of the resin layer 70c. The oxygen transmission rate of the metal layer 70b is about 1/100 of the oxygen transmission rate of the resin layer 70c. Thus, the heat-absorbing member 50 of an embodiment can suppress the permeation of the heat-absorbing agent 60 as compared with a case where the heat-absorbing agent 60 permeates to the outside only through the resin layer 70c. Therefore, a decrease in the heat-absorbing agent 60 can be suppressed, and a decrease in safety of the battery pack 1 can be suppressed.

The metal layers 70b may be joined to each other in a state in which the metal layers 70b are melted. Specifically, the joint portion 70b1 in which the metal layers 70b are in close contact with each other and overlap each other is irradiated with a laser beam. As a result, the metal layers 70b are melted and joined to each other.

When the metal layers 70b are joined to each other, ultrasonic vibration may be applied to the pair of pressing members 2. As a result, at the joint portion 70b1, the metal layers 70b are rubbed against each other, and the metal layers 70b are melted and joined to each other.

In the manufacturing step of the exterior member 70, instead of the first manufacturing step and the second manufacturing step, after an exterior sheet including the metal layer 70b and the resin layer 70c is manufactured, the exterior sheet may be molded into the shape of the exterior member 70 illustrated in FIG. 7B by press working or the like. The exterior sheet is formed by, for example, insert molding in which the resin layer 70c is molded in a state in which a metal foil or the like constituting the metal layer 70b is inserted into a mold in advance. In the third manufacturing step illustrated in FIG. 7C, the exterior sheets are stacked in the sealing portion 72, and the metal layers 70b are joined to each other.

The heat-absorbing member 50 has a hollow columnar shape as described above, and has a rhombic shape in sectional view. The exterior member 70 is made of the material described above. The heat-absorbing member 50 functions as a cushion that absorbs impact by enclosing the heat-absorbing agent 60. That is, the heat-absorbing member 50 has elasticity. The heat-absorbing member 50 is disposed between the plurality of secondary batteries 41 to space the secondary batteries 41 apart from each other (see FIG. 2). As a result, when an impact is applied to the battery pack 1, the heat-absorbing member 50 prevents collision between the secondary batteries 41 and absorbs the impact. Thus, when an impact acts on the battery pack 1, the impact acting on the secondary battery 41 can be suppressed.

Next, an operation of the battery pack 1 when the secondary battery 41 abnormally generates heat will be described. The abnormal heat generation of the secondary battery 41 is caused by, for example, a short circuit of the secondary battery 41 or heating from the outside.

The heat-absorbing member 50 is in contact with the secondary battery 41, and the temperature of the exterior member 70 and the temperature of the heat-absorbing agent 60 increase due to the abnormal heat generation of the secondary battery 41. The internal pressure of the exterior member 70 increases due to the temperature rise of the heat-absorbing agent 60, and the sealing portion 72 is cleaved while the joint portion 70b1 serves as a starting point. As a result, the heat-absorbing agent 60 adheres to the secondary battery 41. Furthermore, the heat-absorbing agent 60 adhering to the secondary battery 41 evaporates, and the temperature of the secondary battery 41 decreases. When the heat-absorbing agent 60 has fluidity, the heat-absorbing agent 60 moves along the outer surface of the secondary battery 41, so that a contact area between the heat-absorbing agent 60 and the secondary battery 41 increases as compared with the case where the heat-absorbing agent 60 does not have fluidity, and the temperature of the secondary battery 41 can be lowered early.

In addition, as the temperature of the exterior member 70 increases, the exterior member 70 is softened, and the exterior member 70 may be cleaved while a portion of the exterior member 70 softened by the increase in the internal pressure of the exterior member 70 serves as a starting point.

In addition, the cleavage valve 41g may be opened due to the abnormal heat generation of the secondary battery 41, and the exterior member 70 may be heated by a gas, a spark, or the like ejected from the cleavage valve 41g, and cleaved while a portion of the exterior member 70 heated by a spark or the like serves as a starting point. The spark is generated from a part of, for example, current collecting foil and an electrode.

As described above, the metal layer 70b is thinner than the resin layer 70c and has a thin film shape, and the metal layer 70b is relatively easily cleaved at the time of abnormal heat generation of the secondary battery 41.

Next, description will be made on the battery pack 1 according to a variation of an embodiment mainly for a difference from the battery pack 1 described above.

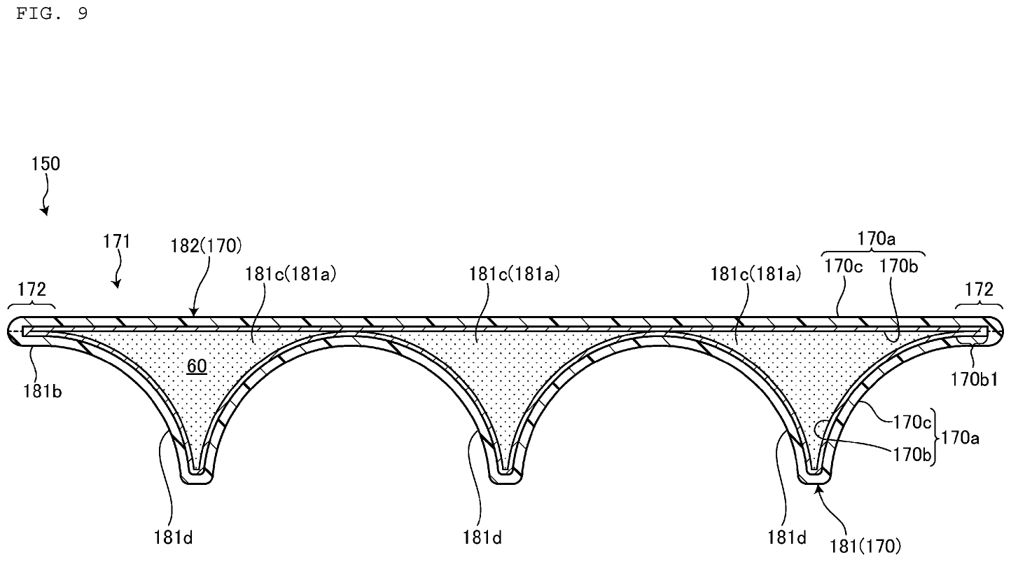

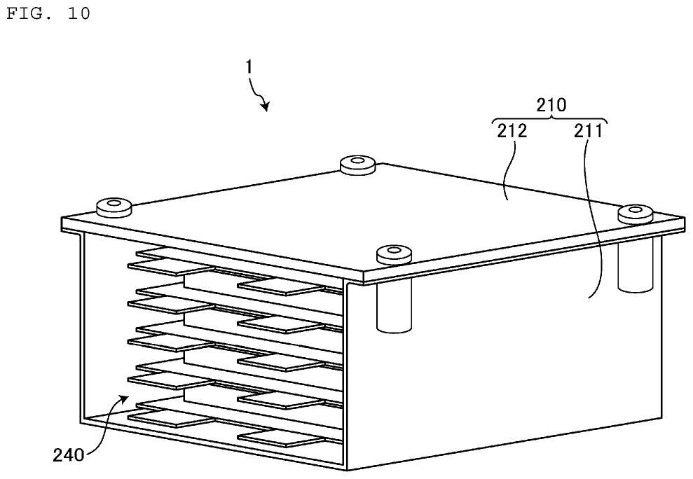

FIG. 8 is an exploded perspective view of an exterior member 170 of the battery pack 1 according to a variation of an embodiment. FIG. 9 is a transverse sectional view of a heat-absorbing member 150 of the battery pack 1 according to the variation of an embodiment. The exterior member 170 of the present variation includes a first exterior member 181 and a second exterior member 182. As illustrated in FIG. 9, the first exterior member 181 and the second exterior member 182 are formed of an exterior sheet 170a.

As illustrated in FIG. 8, the first exterior member 181 includes a first recess 181a and a first flange portion 181b. The first recess 181a has a plurality of grooves 181c arranged in parallel. Furthermore, the first exterior member 181 has a bottom surface on which a plurality of second curved surfaces 181d in contact with the outer peripheral surface of the secondary battery 41 are arranged in parallel. The first exterior member 181 has a wavy shape in sectional view. The first flange portion 181b is formed continuously from the first recess 181a, and disposed over the entire circumference at a peripheral edge of the first recess 181a.

In the first exterior member 181, the resin layer 170c is formed by press molding, vacuum molding, or the like. A metal layer 170b is formed on a surface opposite to the bottom surface by vapor deposition, plating, or the like after the resin layer 170c is formed. When the metal layer 170b is formed by plating, the thickness of the metal layer 170b is about between 0.1 μm and 5 μm. In the first flange portion 181b, the resin layer 170c is located outside the metal layer 170b in plan view.

The second exterior member 182 covers the first recess 181a. The second exterior member 182 has a plate shape. In the second exterior member 182, the resin layer 170c is formed by press molding or the like. In the second exterior member 182, the metal layer 170b is formed on a surface of the resin layer 170c facing the first exterior member 181 by vapor deposition, plating, or the like. In the peripheral edge portion of the second exterior member 182, the resin layer 170c is located outside the metal layer 170b in plan view.

The first flange portion 181b of the first exterior member 181 and the peripheral edge portion of the second exterior member 182 are overlapped and pressed by the pair of pressing members 2, whereby the sealing portion 172 is formed. In the sealing portion 172, a joint portion 170b1 where the metal layer 170b of the first exterior member 181 and the metal layer 170b of the second exterior member 182 are joined to each other is formed. As described above, the sealing portion 172 and the joint portion 170b1 are formed over the entire circumference at a peripheral edge portion of the exterior member 170 in plan view. A portion of the resin layer 170c sandwiched by the pair of pressing members 2 may be a thin-walled portion that overlaps the joint portion 170b1 and is thinner than a portion of the resin layer 170c corresponding to a thick-walled portion not sandwiched by the pair of pressing members 2.

In a portion of the sealing portion 172 outside the joint portion 170b1 in plan view, the resin layer 170c of the first exterior member 181 and the resin layer 170c of the second exterior member 182 are joined to each other over the entire circumference of the peripheral edge portion of the exterior member 170. A portion of the exterior member 170 inside the sealing portion 172 in plan view corresponds to the accommodating portion 171. In the heat-absorbing member 150, the metal layer 170b directly surrounds the heat-absorbing agent 60 and is wholly covered with the resin layer 170c.

In FIG. 2, the exterior member 170 of the present variation can be positioned on a side opposite to the exterior member 70 of the above embodiment with the secondary battery 41 interposed therebetween.

Next, description will be made on the battery pack 1 according to a variation of an embodiment mainly for a difference from the battery pack 1 described above.

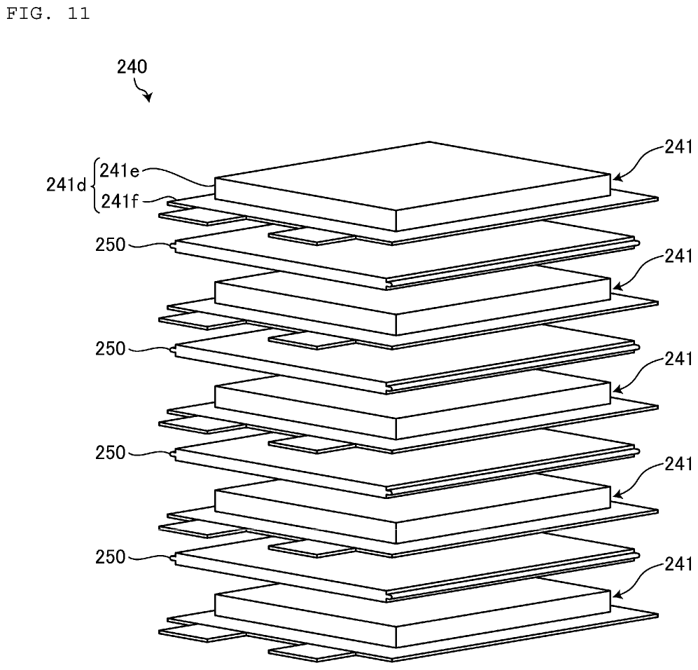

FIG. 10 is a perspective view of the battery pack 1 according to an embodiment of the present disclosure. The battery pack 1 of an embodiment includes an exterior case 210 and a battery unit 240. The exterior case 210 includes a first case portion 211 having a U-shape in sectional view and a second case portion 212 disposed at an open end of the first case portion 211.

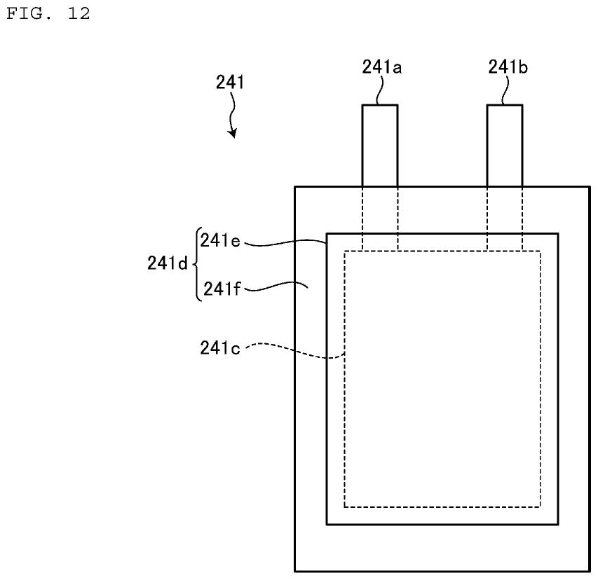

FIG. 11 is an exploded perspective view of the battery unit 240 illustrated in FIG. 10. The battery unit 240 includes a plurality of secondary batteries 241 and a plurality of heat-absorbing members 250. The plurality of secondary batteries 241 and the plurality of heat-absorbing members 250 each have a plate shape, and are stacked in a state in which one of the heat-absorbing members 250 is sandwiched between two of the secondary batteries 241. The secondary battery 241 and the heat-absorbing member 250 adjacent to each other are in contact with each other.

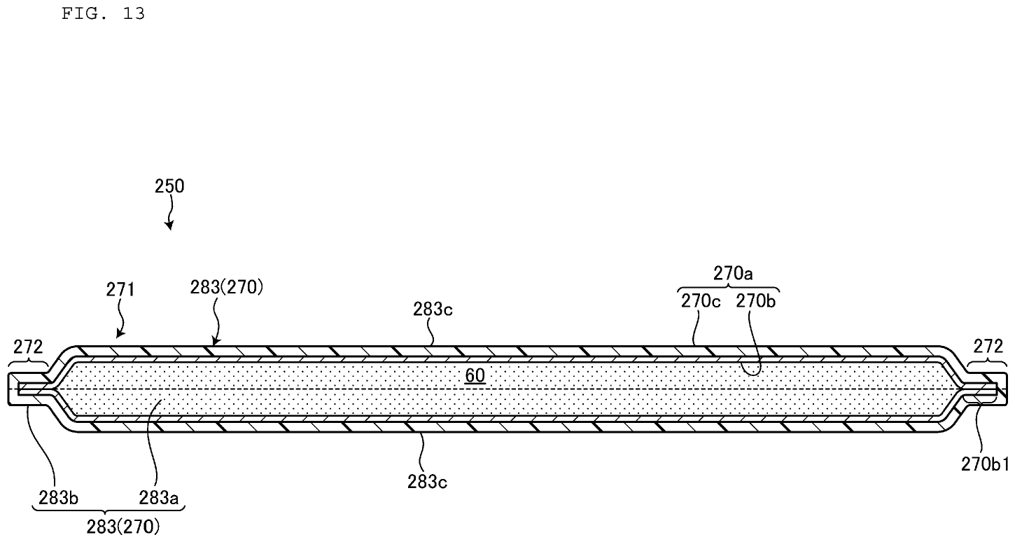

FIG. 12 is a plan view of the secondary battery 241 illustrated in FIG. 11. The secondary battery 241 includes a positive electrode terminal 241a, a negative electrode terminal 241b, an electrode assembly 241c, and an exterior body 241d. The positive electrode terminal 241a and the negative electrode terminal 241b have a band shape.

The electrode assembly 241c is of a wound type, and a long positive electrode (not illustrated) and a long negative electrode (not illustrated) are stacked and wound with a separator (not illustrated) interposed therebetween. The electrode assembly 241c has a rectangular shape in plan view. The electrode assembly 241c may be a laminate in which a plurality of sheet-like positive electrodes and a plurality of sheet-like negative electrodes are alternately stacked with the separator interposed therebetween.

The positive electrode terminal 241a is electrically connected to the positive electrode. A part of the positive electrode terminal 241a is located outside the exterior body 241d. The negative electrode terminal 241b is electrically connected to the negative electrode. A part of the negative electrode terminal 241b is located outside the exterior body 241d.

As illustrated in FIGS. 11 and 12, the exterior body 241d includes an electrode housing portion 241e and a battery flange portion 241f. The electrode housing portion 241e accommodates the electrode assembly 241c. In addition, the electrode housing portion 241e accommodates an electrolyte (for example, a nonaqueous electrolytic solution). The exterior body 241d is formed by, for example, bending a film.

FIG. 13 is a sectional view of the heat-absorbing member 250 illustrated in FIG. 11. The exterior member 270 included in the heat-absorbing member 250 of an embodiment includes two third exterior members 283. The third exterior member 283 is formed of an exterior sheet 270a. The third exterior member 283 has a second recess 283a and a second flange portion 283b. The third exterior member 283 has a bottom surface on which a flat surface 283c in contact with an outer surface of the secondary battery 241 is disposed. The second flange portion 283b is formed continuously from the second recess 283a, and disposed over the entire circumference at a peripheral edge of the second recess 283a.

The third exterior member 283 is formed in the same manner as the first exterior member 181 according to the variation of an embodiment.

The second flange portions 283b of the two third exterior members 283 overlap each other and are pressed by the pair of pressing members 2, whereby the sealing portion 272 is formed. In the sealing portion 272, a joint portion 270b1 where the metal layers 270b of the two third exterior members 283 are joined to each other is formed. As described above, the sealing portion 272 and the joint portion 270b1 are formed over the entire circumference at a peripheral edge portion of the exterior member 270 in plan view. A portion of the resin layer 270c sandwiched by the pair of pressing members 2 may be a thin-walled portion that overlaps the joint portion 270b1 and is thinner than a portion of the resin layer 270c corresponding to a thick-walled portion not sandwiched by the pair of pressing members 2.

In a portion of the sealing portion 272 outside the joint portion 270b1 in plan view, the resin layers 270c of the two third exterior members 283 are joined to each other over the entire circumference of the peripheral edge portion of the exterior member 270. A portion of the exterior member 270 inside the sealing portion 272 in plan view corresponds to the accommodating portion 271. In the heat-absorbing member 250, the metal layer 270b directly surrounds the heat-absorbing agent 60 and is wholly covered with the resin layer 270c.

The present disclosure may be a combination of the following configurations according to an embodiment.
(1)
A battery pack including:
a secondary battery; and
a heat-absorbing member that includes a heat-absorbing agent and an exterior member accommodating the heat-absorbing agent and is in contact with the secondary battery at least in part,
the exterior member including a metal layer, a resin layer overlapping the metal layer, and a sealing portion sealing the heat-absorbing agent,
the metal layer being located inside the exterior member with respect to the resin layer, and
the metal layers being joined to each other at the sealing portion.
(2)
The battery pack according to (1), wherein the resin layer is disposed outside the exterior member with respect to the metal layer over the entire metal layer.
(3)
The battery pack according to (1) or (2), wherein the resin layer includes a thin-walled portion overlapping a joint portion of the exterior member where the metal layers are joined to each other, and a thick-walled portion thicker than the thin-walled portion.
(4)
The battery pack according to any one of (1) to (3), wherein the metal layer is thinner than the resin layer.
(5)
The battery pack according to any one of (1) to (4),
wherein the secondary battery has a cylindrical shape, and
the heat-absorbing member has elasticity and is in contact with an outer peripheral surface of the secondary battery.
(6)
The battery pack according to (5), further including a plurality of the secondary batteries,
wherein the exterior member has a columnar shape having, on its side surface, a plurality of first curved surfaces in contact with the outer peripheral surface of the secondary battery.
(7)
The battery pack according to (5), further including a plurality of the secondary batteries,
wherein
the exterior member includes a first exterior member having a recess and a second exterior member covering the recess, and
the first exterior member has a bottom surface on which a plurality of second curved surfaces in contact with the outer peripheral surface of the secondary battery are arranged in parallel.
(8)
The battery pack according to any one of (1) to (7), wherein a material of the metal layer contains at least one metal element selected from the group consisting of aluminum, zinc, chromium, and nickel.
(9)
The battery pack according to any one of (1) to (7), wherein a material of the metal layer is any one of an aluminum alloy and a nickel alloy.
(10)
The battery pack according to any one of (1) to (9), wherein the exterior member is formed of an exterior sheet including the metal layer and the resin layer.

Note that the embodiments described herein are intended to facilitate understanding of the present disclosure, but not intended to construe the present disclosure in any limited way. The present disclosure can be modified or improved including equivalents thereof without departing from the scope and spirit of the present disclosure. It is therefore intended that such changes and modifications be covered by the appended claims.

What is claimed is:

1. A battery pack comprising:
a secondary battery; and
a heat-absorbing member that includes a heat-absorbing agent and an exterior member accommodating the heat-absorbing agent and is in contact with the secondary battery at least in part,
the exterior member including a metal layer, a resin layer overlapping the metal layer, and a sealing portion sealing the heat-absorbing agent,
the metal layer being located inside the exterior member with respect to the resin layer, and
the metal layers being joined to each other at the sealing portion.

2. The battery pack according to claim 1, wherein the resin layer is disposed outside the exterior member with respect to the metal layer over the entire metal layer.

3. The battery pack according to claim 1, wherein the resin layer includes a thin-walled portion overlapping a joint portion of the exterior member where the metal layers are joined to each other, and a thick-walled portion thicker than the thin-walled portion.

4. The battery pack according to claim 1, wherein the metal layer is thinner than the resin layer.

5. The battery pack according to claim 1, wherein
the secondary battery has a cylindrical shape, and
the heat-absorbing member has elasticity and is in contact with an outer peripheral surface of the secondary battery.

6. The battery pack according to claim 5, further comprising a plurality of the secondary batteries,
wherein the exterior member has a columnar shape having, on its side surface, a plurality of first curved surfaces in contact with the outer peripheral surface of the secondary battery.

7. The battery pack according to claim 5, further comprising a plurality of the secondary batteries,
wherein
the exterior member includes a first exterior member having a recess and a second exterior member covering the recess, and
the first exterior member has a bottom surface on which a plurality of second curved surfaces in contact with the outer peripheral surface of the secondary battery are arranged in parallel.

8. The battery pack according to claim 1, wherein a material of the metal layer contains at least one metal element selected from the group consisting of aluminum, zinc, chromium, and nickel.

9. The battery pack according to claim 1, wherein a material of the metal layer is any one of an aluminum alloy and a nickel alloy.

10. The battery pack according to claim 1, wherein the exterior member includes an exterior sheet including the metal layer and the resin layer.
